(19) United States
(12) Patent Application Publication
(10) Pub. No.: US 2013/0217456 A1
(43) Pub. Date: Aug. 22, 2013

(54) MODIFIED BLACKJACK WAGERING GAME METHODS AND SYSTEMS

(71) Applicants: Greg Jaffa, Wayne, NJ (US); Paul Jaffa, Wayne, NJ (US)

(72) Inventors: Greg Jaffa, Wayne, NJ (US); Paul Jaffa, Wayne, NJ (US)

(21) Appl. No.: 13/772,541

(22) Filed: Feb. 21, 2013

Related U.S. Application Data
(60) Provisional application No. 61/601,146, filed on Feb. 21, 2012.

(51) Int. Cl. G07F 17/32; A63F 1/00

(52) U.S. Cl. CPC G07F 17/326; A63F 1/00
USPC 463/12; 273/274

(57) ABSTRACT

Systems and methods for providing, conducting and hosting wagering games in which players may place wagers and receive player hands including providing three randomly-drawn playing cards for each of the one or more participating players, receiving a selection of the shared card from each player, wherein the shared card is one of the three playing cards and assigning the remaining two cards from the three playing cards to a first Blackjack hand and a second Blackjack hand, respectively, and continuing with the Blackjack game until the game is resolved for the first and second Blackjack hands, wherein each of the first and second Blackjack hands include the shared card.

### CROSS-REFERENCE TO RELATED APPLICATIONS FROM WHICH PRIORITY IS CLAIMED

This application claims the benefit of U.S. Provisional Patent Application No. 61/601,146 which was filed Feb. 21, 2012, the disclosure of which is incorporated herein by reference.

### BACKGROUND

1. Field of the Invention

The present invention relates to systems and methods of providing, conducting and modifying wagering games. In particular, the invention relates to a system and method for providing and conducting a modified Blackjack card game.

2. Description of the Related Art

Many card games have been developed over the years and some are particularly adapted for gambling. Typically, such games include a dealer who deals cards and one or more players who place wagers on whether an outcome will be achieved based on the cards that the dealer deals. One example in this regard is Blackjack which is also known as Twenty-One.

The objective of Blackjack is for a wagering player to finish a round of play with a hand of playing cards with a sum of the total value of cards coming as close as possible to the value of twenty-one, without the player hand total exceeding twenty-one. The game is played by one or more players against a dealer with the player making an initial wager on a final outcome under the rules of Blackjack, which remain fairly consistent throughout the world, and with only minor variations in different casinos or jurisdictions. Players' hands that are less than or equal to twenty-one, and exceed the value of the dealer's hand wins. All players' hands that have a lower sum than the dealer's hand and all hands that exceed the sum of twenty-one lose. Dealer and Player hands with the same total value (without the player first busting, result in ties (called a “push”). An initial two-card hand totaling twenty-one points is called Blackjack, and in the absence of the dealer having a similar hand, automatically wins, without respect to the dealer's hand final; count and is often paid at odds greater than 1:1.

One conventional method of playing Blackjack uses one or more standard decks of playing cards (a fifty-two card deck without jokers). Each numbered card is counted according to its face value. The Jacks, Queens and Kings are worth ten (10), and Aces are worth either one (1) or eleven (11), depending on which is most beneficial to the count of the hand. A “ten” card therefore hereinafter includes any card which has a value of ten in the game of Blackjack, that is, a numbered 10 card, Jacks, Queens and Kings.

Once all the bets are made, the dealer will deal the cards to the players. The dealer will make two passes around the table starting with the player farthest to the left so that the players and the dealer have one card after the first pass and then receive a second card each after the second pass. The two cards dealt to the dealer or house includes one card face up or otherwise exposed to view, usually the second (and last) card dealt.

A player views an initial value of cards in the player's hand, views the dealer's up-card (the exposed card) and then makes decisions on drawing or not drawing further playing cards. This further drawing is done in an attempt to try and win the hand by having a higher count than the dealer's hand without busting, or allowing the dealer to bust the house hand. The player can “stand” on any count of twenty-one or less. Once the player exceeds a count of twenty-one or “busts,” the player wager is lost, whatever the ultimate point count of the dealer's hand. Usually, the dealer must hit when with a point count of less than seventeen. Normally a dealer must stand on a soft count of at least seventeen, a soft count being a hand value where an Ace is counted as a value of eleven. House rules may vary, however.

Although the game of Blackjack is a consistent winning game for the house, players tend to place the minimum wager on a Blackjack game unless the player is using some system or feels that the cards are running in a favorable streak. While Blackjack is a very popular game, many new games which are quickly rising in popularity provide numerous wagering opportunities, thus increasing player participation and excitement. Consequently, further variations of existing wagering games are always of interest to players and casinos, and therefore, there is a desire for methods which would increase wagering in the game of Blackjack.

### SUMMARY OF THE INVENTION

The invention relates generally to systems and methods of modifying, providing and conducting wagering games, and more particularly, multilayered wagering games.

Some embodiments of the invention are directed to a method of providing a wagering game at a gaming table comprising the steps of: displaying one or more wagering areas and indicia relating to associated wagering opportunities; providing one or more decks of randomly-ordered physical playing cards; receiving at least two game wagers from one or more participating players; distributing three playing cards to each of the one or more participating players from the one or more decks of physical playing cards to form a first Blackjack hand and a second Blackjack hand at the gaming table, wherein one of the three playing cards forms one of the cards of the first Blackjack hand, one of the three playing cards forms one of the cards of the second Blackjack hand and one of the three playing cards forms a shared card for both the first and the second Blackjack hands; distributing a dealer Blackjack hand at the gaming table including at least two playing cards from the one or more decks of physical playing cards; and continuing with the Blackjack game until the game is resolved for the first and second Blackjack hands.

In some embodiments, the aforementioned method further includes the steps of providing a table layout with one or more wagering areas and indicia printed thereon.

In some embodiments, the step of receiving at least two game wagers from one or more participating players further includes receiving a first wager for the first Blackjack hand and a second wager for the second Blackjack hand.

In some embodiments, the aforementioned method further includes the steps of assigning one of the three playing cards as being one of the cards of the first Blackjack hand, assigning one of the three playing cards as being one of the cards of the second Blackjack hand and assigning one of the three playing cards as being a shared card for both the first and the second Blackjack hands responsive to the order distributed.

In some embodiments, the aforementioned method further includes the steps of: receiving a selection of the shared card from the three playing cards from each player; and assigning one of the three playing cards as being one of the cards of the first Blackjack hand, assigning one of the three playing cards as being one of the cards of the second Blackjack hand and one of the three playing cards as being a shared card for both the first and the second Blackjack hands responsive to receipt of the player selection.

In some embodiments, the aforementioned method further includes the steps of: receiving a side wager from one or more players; comparing the three cards distributed to each player with a preset criteria responsive to receiving a side wager from the player, wherein the preset criteria relates to one or more poker rankings and one or more associated payout amounts; and settling the side wager by either awarding a payout amount to the player if the player placed a side wager and the corresponding preset criteria for the side wager is satisfied, wherein the payout amount depends at least in part of the preset criteria satisfied or collecting the side wager.

Some embodiments of the invention are directed to a method of providing a wagering game at a gaming table comprising the steps of: displaying one or more wagering areas and indicia relating to associated wagering opportunities; providing one or more decks of randomly-ordered physical playing cards; receiving a first game wager and a second game wager from one or more participating players; distributing three playing cards to each of the one or more participating players from the one or more decks of physical playing cards; receiving a selection of the shared card from each player, wherein the shared card is one of the three playing cards distributed; assigning the remaining two cards from the three playing cards to a first Blackjack hand and a second Blackjack hand responsive to receipt of the player selection, wherein one of the remaining two playing cards is assigned to the first Blackjack hand the other of the remaining two cards is assigned to the second Blackjack hand; distributing a dealer Blackjack hand at the gaming table including at least two playing cards from the one or more decks of physical playing cards; continuing with the Blackjack game until the game is resolved for the first and second Blackjack hands, wherein the first and second Blackjack hands include the shared card; and settling the first and second game wagers based on the respective outcomes of the Blackjack game for the first and second Blackjack hands.

In some embodiments, the aforementioned method further includes the steps of: receiving a side wager from one or more players; comparing the three cards distributed to each player with a preset criteria responsive to receiving a side wager from the player, wherein the preset criteria relates to one or more poker rankings and one or more associated payout amounts; and settling the side wager by either awarding a payout amount to the player if the corresponding preset criteria for the side wager is satisfied, wherein the payout amount depends at least in part of the preset criteria satisfied or collecting the side wager.

Some embodiments of the invention are directed to a computer-facilitated method of providing a wagering game comprising one or more processors, display devices, communication devices and data storage devices, all for facilitating the steps of: comprising the steps of: displaying one or more wagering areas and indicia relating to associated wagering opportunities; receiving at least two game wagers from one or more participating players; displaying three randomly-drawn playing cards for each of the one or more participating players; receiving a selection of the shared card from each player, wherein the shared card is one of the three playing cards displayed; assigning the remaining two cards from the three playing cards to a first Blackjack hand and a second Blackjack hand responsive to receipt of the player selection, wherein one of the remaining two playing cards is assigned to the first Blackjack hand the other of the remaining two cards is assigned to the second Blackjack hand; displaying a dealer Blackjack hand including at least two randomly-drawn playing cards; continuing with the Blackjack game until the game is resolved for the first and second Blackjack hands, wherein the first and second Blackjack hands include the shared card; and settling the first and second wagers based on the respective outcomes of the Blackjack game for the first and second Blackjack hands.

In some embodiments, the one or more processors, communication devices and data storage devices are further configured for: receiving a side wager from one or more players; comparing the three cards distributed to each player with a preset criteria responsive to receiving a side wager from the player, wherein the preset criteria relates to one or more poker rankings and one or more associated payout amounts; and settling the side wager by either awarding a payout amount to the player if the player placed a side wager and the corresponding preset criteria for the side wager is satisfied, wherein the payout amount depends at least in part of the preset criteria satisfied or collecting the side wager.

In some embodiments, the communication devices transmit information via a global telecommunication and/or computing network. The one or more processors, communication devices and data storage devices may be mounted in a unitary housing or remotely from one another.

Some embodiments of the invention are also directed to a non-transitory machine readable media for providing a wagering gaming method such as those described herein including one or more software programs, code and/or data segments as necessary to provide any of the methods described herein on one or more machines or to facilitate the installation and operation of such methods in systems described herein.

### BRIEF DESCRIPTION OF THE DRAWINGS

FIG. 1 is a process flow chart depicting an exemplary embodiment of the invention.

FIG. 2 is process flow chart depicting another exemplary embodiment of the invention.

FIG. 3 is a schematic diagram of an exemplary table layout configured for use with methods according to some embodiments of the invention, including physical or live table systems and virtual or partially virtual electronic platforms.

FIG. 4 is a schematic diagram of exemplary system components configured for use with methods according to some embodiments of the invention.

### DETAILED DESCRIPTION OF THE INVENTION

The exemplary embodiments herein relate to wagering games. It should be understood that each of the methods and individual steps recited herein may be partially or wholly carried out in a variety of ways and/or systems, which may include, but are not limited to, a live dealer physically dealing playing cards in a casino, an electronic gaming machine (EGM) for use by one or more players, a multiplayer platform which may include a player interface such as a touchscreen display and involve physical or virtual playing cards, dealer and wagering chips, a home computer or portable computing device, such as a tablet computer or mobile phone capable of communicating with a network or over the Internet, global telecommunication network or world wide web.

It should further be understood that the invention is directed to, among other things, methods of providing, conducting and resolving wagering games that include a sequence of controlled and concrete transformative events. Some of these events may involve wagering, the generation of random data, the application of randomly-generated data to predefined rules, the determination of wager outcomes in accordance with preset outcome determining criteria, the notification of such outcomes, awarding of payouts and collecting of wagers. The generation of random data may be facilitated by computerized and/or physical implements. The transformative events may also include parsing of the data for comparative purposes with preset criteria to determine an outcome in a second, bonus or associated wagering game.

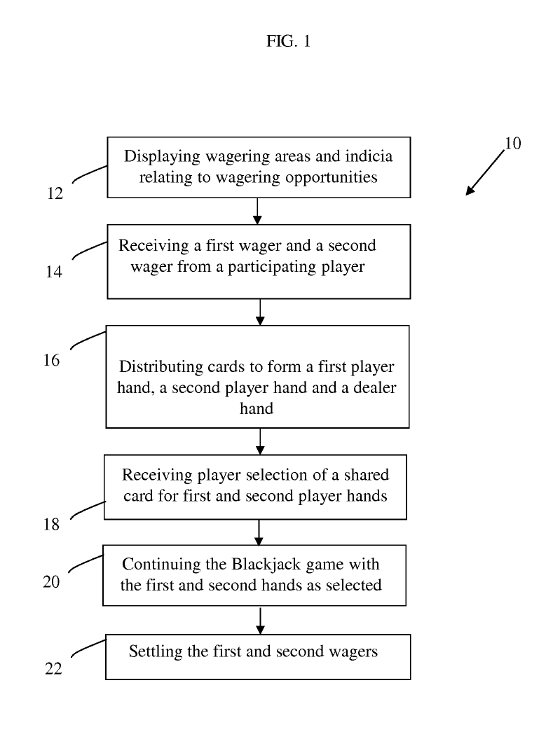

In some embodiments, the invention is directed to a method of playing a modified version of an underlying game, such as Blackjack, generally referred to by the reference numeral 10 which includes various steps as shown in FIG. 1.

It should be understood that, other than the modifications discussed herein, gaming method or game 10 may include the rules of a conventional or modified version of an underlying Blackjack game. For example, in some modified versions, all of the ten value cards may be removed from the deck prior to play, or if the dealer gets a point total of 22, then any and all players' hands of 20 or less will be considered a push, with only players having a Blackjack or a total of a natural 21 being paid. In other versions, a natural Blackjack pays even money, or players and dealers push if the dealer hand is also a natural Blackjack or otherwise equals “21” value. In yet other versions, splitting is not allowed or players may or may not “hit” that is receive additional cards, or may only receive a limited amount of additional cards prior to busting.

As shown by step 12, method 10 may be facilitated by providing a table layout so that wagering areas and indicia relating to wagering opportunities may be displayed to potential players and used for the placement of wagers thereon. In this embodiment, the wagering areas include a first wagering area and a second wagering area.

In step 14, two wagers, a first wager and a second wager, are received by a player interested in participating in a game 10. The first and second wagers may be the same or different and may be placed in the corresponding first and second wagering areas. It should be understood that receiving wagers may comprise the player placing an amount at risk, such as placing a gaming chip on designated wagering areas on a table game felt layout provided in step 12.

In step 16, playing cards or virtual representations thereof are distributed or dealt. In game 10, three cards are dealt to each player to form the player's first and a second hands and two cards are dealt to the dealer to form the dealer hand. In some embodiments, the playing cards are dealt in step 14 according to the rules of conventional Blackjack, that is, with each player receiving a first card, beginning with the player to the left-most of the dealer and then proceeding to the right to deal one card to each player until all players have a first card. Once the players each have a first card, then the dealer will receive a first card. The dealer will then deal a second a card to each player following the same pattern but skipping the dealer and then dealing a third card to each player, with the dealer receiving the last card to form the dealer hand after all third cards are dealt to the players. It should be readily apparent that the dealing procedure may differ and may further include discarding or “burning” cards as well.

In step 18, the three cards dealt to each player are used to form both the player's first and second initial hands in the Blackjack game, which in game 10, involves receiving the player's selection of one of the three cards to be the shared card, with the other two of the three cards forming the first and second hands. In other words, one of the three cards will be part of the first hand, one of the three cards will be part of the second hand and the selected card will be a shared card for both the first and second hands. For example, if a player receives a King as a first card, a Eight as a second card and an Seven as a third card, and a player selection of the King as the shared card is received, then the player's first hand is a King and Eight which is an eighteen according to Blackjack rules, and the player's second hand is a King and Seven which is a seventeen according to Blackjack rules.

In other embodiments, the first card dealt to each player constitutes the first one of the cards in that player's first Blackjack hand, the second card dealt to each player constitutes a first one of the cards in that player's second Blackjack hand, and the third card dealt to each player constitutes the second one of the cards in both of that player's first and second Blackjack hands.

Furthermore, it should be understood that the order in which the cards are dealt are non-limiting, in that the cards constituting the first or second of the cards in the two respective hands may be dealt in any order so long as one of the cards dealt to each player constitutes a shared card for both the first and second Blackjack hands. In some embodiments, the player may choose the card for the first hand, the card for the second hand and the shared card from the three cards dealt.

In step 20, game 10 continues according to the rules of the underlying Blackjack game for both the first and second hands for each player against the dealer hand. For purposes of settling the wagers in step 22, the first wager will be won or lost based on the outcome of the first hand against the dealer hand and the second wager will be won or lost based on the outcome of the first hand against the dealer hand according to the rules of the underlying Blackjack game. Thus, in this embodiment, the first and second hands and first and second wagers are determined and settled independently of one another. In other embodiments, both the first and second hands must have a winning outcome for the first and second wager to be won, so that the wagers are both lost if both the first and second hands have a losing outcome, and the wagers push or one of the two wagers is lost if only one of the first and second hands achieves a winning outcome against the dealer hand.

In some embodiments, players may place one or more side wagers, one or some of which may be mandatory. The side wagers are received along with the first and second wager and they may be settled at any time upon revealing of the cards forming the side wager hand. Each of the one or more side wagers are settled by comparing one or more cards forming a side wager hand with preset criterion. Each side wager may correspond with a side wager hand formed of one or more of the following: any two of the three cards dealt to each player; the three cards dealt to the player; the three cards dealt to the player and one of the cards dealt to the dealer such as the dealer's face-up card; and the three cards dealt to the player and both of the cards dealt to the dealer to form the dealer's hand. In some embodiments, all the side wager hand wagers are offered whereas in other embodiments only one side wager hand is offered, such as the side wager on the three cards dealt to each player achieving a preset poker rank on a paytable.

It should be understood that the preset criterion may correspond to any particular feature associated with the playing cards or certain combinations of cards, such as a poker or poker-like hand rank (that is, similar to conventional poker rankings but not necessarily the same card configuration) achieved by the side wager hand or the presence of a particular card in the side wager hand. In other embodiments, the side wager hand may be compared with preset criteria, such as a plurality of poker or poker-like rankings, such as pair, two-pair, three-of-a-kind, straight, flush, full house, straight flush and royal flush. The poker or poker-like rankings may be based on any number of cards in the side wager hand, such as two through five, excluding any rankings which are eliminated based on the number of cards, and may differ depending on the odds of achieving certain hands for more or less than five cards.

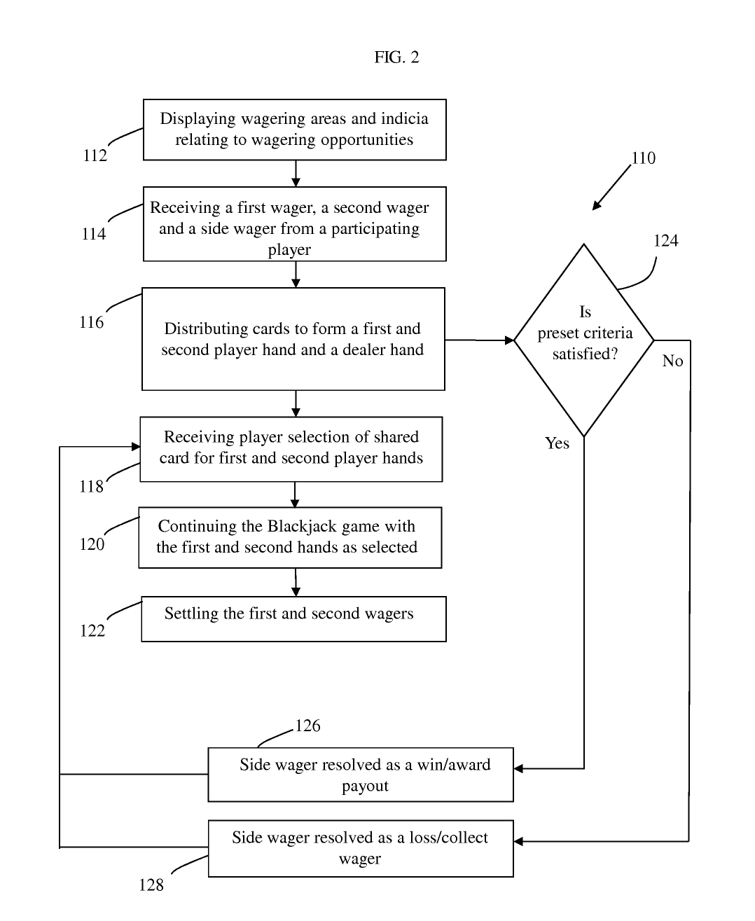

FIG. 2 illustrates another embodiment of a gaming method in accordance with the invention identified by reference numeral 110. In this embodiment a side wager is received in step 114 in addition to the first and second hand wagers.

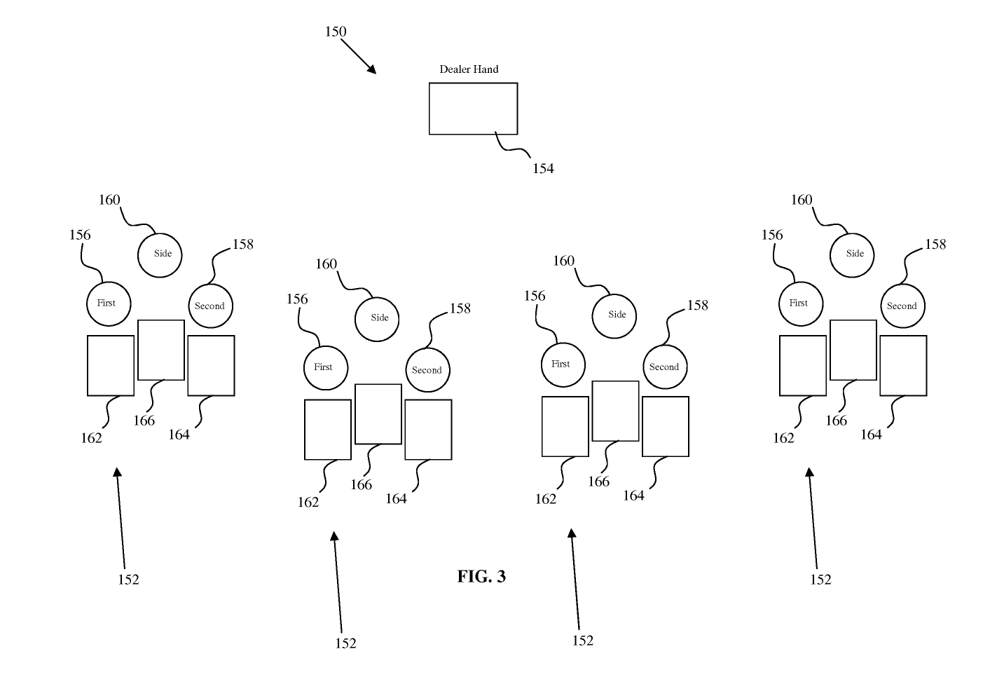

Method 110 may be facilitated in step 112 by providing a table layout such as layout 150 shown in FIG. 3, which can be used to facilitate game play of this embodiment in a gaming establishment. It should be understood that layout 150 may be partially of fully electronic, that is, incorporating touch-enabled screens and electronic wagering. However, for purposes of illustrating the features of this embodiment, the gaming method 110 will be discussed in connection with table game layout 150 as if physical playing cards, physical wagering chips and a live dealer are all involved.

In this embodiment, one of the available side wagers may be based on at least three of the cards in the side wager hand achieving at least a certain poker rank based on three cards. It should be understood that other side wagers based on other amounts of cards in the side wager hand achieving a poker rank, such as those discussed above, may be incorporated in gaming method 110 as well. The side wager may be optional or mandatory. In some embodiments, the side wager may be mandatory. In some embodiments, the side wager may be mandatory to participate with a first and second hand in gaming method 110, and if the side wager is not received then a player may only participate by playing either one or two hands of conventional Blackjack according to normal Blackjack rules, that is, without the shared card feature.

As shown in step 124, if any side wager hand satisfies the preset criterion, then in step 126 the side wager is won and amount may be paid out to the player that placed the side wager in step 112 as an award. If any side wager hand does not satisfy the preset criterion in step 124, then the side wager is lost and collected in step 128. In embodiments in which there is a preset criteria of poker rankings, the award payout may be an odds payout expressed as a multiple of the unit wagered as a side wager in step 114. For example, the payout may be 6 to 1 for a three card flush in the side wager hand.

It should be understood that the side wager payouts may be expressed in such terms as set amounts, odds payouts, multiples of the unit side wager, portions of a standard progressive meter, or combinations thereof.

An exemplary paytable is shown below.

Three Card Side Wager Preset Criteria

| | |
|---|---|
| Mini-Royal (Queen, King, Ace suited) suited | 100 to 1 |
| Straight Flush (Ace, 2, 3 - Jack, Queen, King suited) | 30 to 1 |
| Three of a kind | 25 to 1 |
| Straight (Ace, 2, 3 - Queen, King, Ace) | 10 to 1 |
| Flush | 60 to 1 |

It should be readily apparent that the above paytable is provided for illustrative purposes and may be altered accordingly.

As shown in FIG. 2, after the settling the side wager, the game continues with the receipt of player selections in step 118.

Table game layout 150 includes multiple player positions 152 and a dealer position 154. In this embodiment, there are four player positions 152, each generally including a wagering circle 156 for placing a first wager in game 110, a wagering circle 158 for placing a second wager in game 110 and a wagering circle 160 for placing a side wager available in game 110. Player positions 152 further include first hand area 162, second hand area 164 and shared card area 166. It should be understood that a layout in accordance with the invention may include more or less player positions 152.

Thus, in step 114, participating players place wagers in circles 156, 158, which in this embodiment must be the same amount. Participating players may place a wager in circle 160 if the side wager is optional, or must place a wager in circle 160 if it is mandatory, which may be of equal or different value than the wagers placed in circles 156 and 158. Wagers placed are at risk and thus comprise wagers received by the house. In step 116, cards are dealt in game 110 to player and dealer positions 152 and 154. In this embodiment, the player has the option to select the one card to be shared by both the first and second player hands in step 118, while the side wager hand is comprised of all three cards. The selection may involve the selected shared card being physically placed in shared card area 166, while one of the other two cards is positioned in card area 162 and the other card is placed in card area 164.

In some embodiments, the table layout may be provided via a computer interface. Alternatively, the game methods according to the invention may be implemented and presented by means of computer program code which, by way of example, when executed by a processor, causes the display of the wagering options described herein and game layout.

Those skilled in the art will readily appreciate that the methods described herein may be incorporated in an electronic gaming system in accordance with the invention using virtual representations of table layouts such as layout 150. The system of the invention may include various computer and network related software and hardware, such as programs, operating systems, memory storage devices, data input/output devices, data processors, servers with links to data communication systems, wireless or otherwise, and data transceiving terminals. Those skilled in the art will further appreciate that the precise types of software and hardware used are not vital to the full implementation of the methods of the invention so long as players and operators thereof are provided with useful access thereto, either through a gaming platform, or a mobile device or other computing platform via a global telecommunication network.

Those skilled in the art will readily appreciate that the methods described herein may be included in a system in accordance with the invention using virtual representations of cards and table layouts. The system of the invention may include various computer and network related software and hardware, such as programs, operating systems, memory storage devices, data input/output devices, data processors, servers with links to data communication systems, wireless or otherwise, and data transceiving terminals, and may be a standalone device or incorporated in another platform, such as a mobile device. The system of the invention may be provided on electronic platforms with multiple player positions. In addition, the system of the invention may be provided at least in part on a personal computing device, such as home computer, laptop or mobile computing device through an online communication connection or connection with the Internet. Those skilled in the art will further appreciate that the precise types of software and hardware used are not vital to the full implementation of the methods of the invention so long as players and operators thereof are provided with useful access thereto or the opportunity to play the game as described herein.

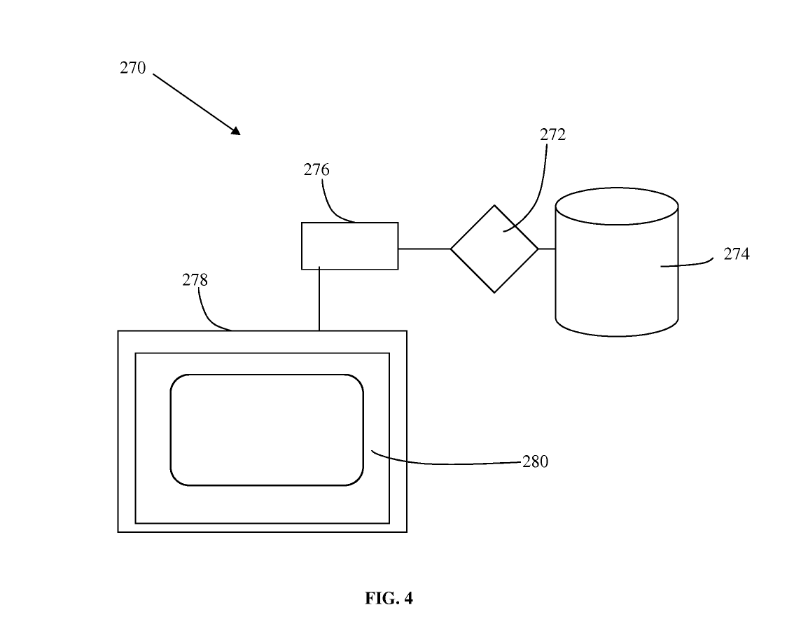

FIG. 4 illustrates an exemplary system 270 constructed in accordance with some embodiments of the invention. System 270 includes processing device 272 in communication with a memory device 274, data input/output device 276 and a display device 278. In some embodiments, display device 278 is a touch-enabled device and includes a data input device component therein. Memory device 274 may include data relating to the underlying game and side wagering game, as well as the preset criteria. A player position, such as player position 152, may be displayed on display device 278. Dealt cards are displayed and player selections may be received via data input/output device 276 or through a touch-enabled display device 278. Processing device 272 runs the Blackjack game and may compare any side wagers with preset criteria stored in memory device 274 in the manner discussed herein and the player's first and second hands in player position 152 with the dealer hand.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth in the claims and equivalents thereto.

What is claimed is:

1. A method of providing a wagering game at a gaming table comprising the steps of:
displaying one or more wagering areas and indicia relating to associated wagering opportunities;
providing one or more decks of randomly-ordered physical playing cards;
receiving at least two game wagers from one or more participating players;
distributing three playing cards to each of the one or more participating players from the one or more decks of physical playing cards to form a first Blackjack hand and a second Blackjack hand at the gaming table, wherein one of the three playing cards forms one of the cards of the first Blackjack hand, one of the three playing cards forms one of the cards of the second Blackjack hand and one of the three playing cards forms a shared card for both the first and the second Blackjack hands;
distributing a dealer Blackjack hand at the gaming table including at least two playing cards from the one or more decks of physical playing cards; and
continuing with the Blackjack game until the game is resolved for the first and second Blackjack hands.

2. The method according to claim 1, wherein the step of displaying one or more wagering areas and indicia relating to associated wagering opportunities further comprising providing a table layout with one or more wagering areas and indicia printed thereon.

3. The method according to claim 1, wherein the step of receiving at least two game wagers from one or more participating players further comprising receiving a first wager for the first Blackjack hand and a second wager for the second Blackjack hand.

4. The method according to claim 3, wherein the first and second wagers must be equal.

5. The method according to claim 1, further comprising the steps of assigning one of the three playing cards as being one of the cards of the first Blackjack hand, assigning one of the three playing cards as being one of the cards of the second Blackjack hand and assigning one of the three playing cards as being a shared card for both the first and the second Blackjack hands responsive to the order distributed.

6. The method according to claim 1, further comprising the steps of: receiving a selection of the shared card from the three playing cards from each player; and assigning one of the three playing cards as being one of the cards of the first Blackjack hand, assigning one of the three playing cards as being one of the cards of the second Blackjack hand and one of the three playing cards as being a shared card for both the first and the second Blackjack hands responsive to receipt of the player selection.

7. The method according to claim 1, further comprising the steps of: receiving a side wager from one or more players; comparing the three cards distributed to each player with a preset criteria responsive to receiving a side wager from the player, wherein the preset criteria relates to one or more poker rankings and one or more associated payout amounts; and settling the side wager by either awarding a payout amount to the player if the player placed a side wager and the corresponding preset criteria for the side wager is satisfied, wherein the payout amount depends at least in part of the preset criteria satisfied or collecting the side wager.

8. A method of providing a wagering game at a gaming table comprising the steps of:
displaying one or more wagering areas and indicia relating to associated wagering opportunities;
providing one or more decks of randomly-ordered physical playing cards;
receiving a first game wager and a second game wager from one or more participating players;
distributing three playing cards to each of the one or more participating players from the one or more decks of physical playing cards;
receiving a selection of the shared card from each player, wherein the shared card is one of the three playing cards distributed;
assigning the remaining two cards from the three playing cards to a first Blackjack hand and a second Blackjack hand responsive to receipt of the player selection, wherein one of the remaining two playing cards is assigned to the first Blackjack hand the other of the remaining two cards is assigned to the second Blackjack hand;
distributing a dealer Blackjack hand at the gaming table including at least two playing cards from the one or more decks of physical playing cards;
continuing with the Blackjack game until the game is resolved for the first and second Blackjack hands, wherein each of the first and second Blackjack hands include the shared card; and
settling the first and second game wagers based on the respective outcomes of the Blackjack game for the first and second Blackjack hands.

9. The method according to claim 8, further comprising the steps of: receiving a side wager from one or more players; comparing the three cards distributed to each player with a preset criteria responsive to receiving a side wager from the player, wherein the preset criteria relates to one or more poker rankings and one or more associated payout amounts; and settling the side wager by either awarding a payout amount to the player if the corresponding preset criteria for the side wager is satisfied, wherein the payout amount depends at least in part of the preset criteria satisfied or collecting the side wager.

10. A computer-facilitated method of providing a wagering game comprising one or more processors, display devices, communication devices and data storage devices, all for facilitating the steps of: comprising the steps of:
displaying one or more wagering areas and indicia relating to associated wagering opportunities;
receiving at least two game wagers from one or more participating players;
displaying three randomly-drawn playing cards for each of the one or more participating players;
receiving a selection of the shared card from each player, wherein the shared card is one of the three playing cards displayed;
assigning the remaining two cards from the three playing cards to a first Blackjack hand and a second Blackjack hand responsive to receipt of the player selection, wherein one of the remaining two playing cards is assigned to the first Blackjack hand the other of the remaining two cards is assigned to the second Blackjack hand;
displaying a dealer Blackjack hand including at least two randomly-drawn playing cards;
continuing with the Blackjack game until the game is resolved for the first and second Blackjack hands, wherein the first and second Blackjack hands include the shared card; and
settling the first and second wagers based on the respective outcomes of the Blackjack game for the first and second Blackjack hands.

11. The computer-implemented method according to claim 10, wherein the communication devices transmit information via a global computing network.

12. The computer-implemented method according to claim 10, wherein the communication devices transmit information via a satellite network.

13. The computer-implemented method according to claim 10, wherein the one or more processors, communication devices and data storage devices are mounted in a unitary housing.

14. The computer-implemented method according to claim 10, wherein the one or more processors, communication devices and data storage devices are further configured for:
receiving a side wager from one or more players; comparing the three cards distributed to each player with a preset criteria responsive to receiving a side wager from the player, wherein the preset criteria relates to one or more poker rankings and one or more associated payout amounts; and
settling the side wager by either awarding a payout amount to the player if the player placed a side wager and the corresponding preset criteria for the side wager is satisfied, wherein the payout amount depends at least in part of the preset criteria satisfied or collecting the side wager.
